(19) United States
(12) Patent Application Publication
(10) Pub. No.: US 2011/0033215 A1
(43) Pub. Date: Feb. 10, 2011

(54) FUSER, IMAGE FORMING APPARATUS, AND FUSING METHOD

(75) Inventor: Shuji YOKOYAMA, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/832,667

(22) Filed: Jul. 8, 2010

Related U.S. Application Data
(60) Provisional application No. 61/232,709, filed on Aug. 10, 2009.

(30) Foreign Application Priority Data
Feb. 25, 2010 (JP) 2010-039466

(51) Int. Cl. G03G 15/20

(52) U.S. Cl. 399/328; 399/329

(57) ABSTRACT

According to one embodiment, a fuser includes a rotatable heating member having a plurality of holes formed on difference areas, which are not overlapped with each other and which are the difference between an area in the rotating direction where a sheet having a first width is in contact during the conveyance and an area in the rotating direction where a sheet having a second width, different from the first width, is in contact during the conveyance, and a rotatable pressing member that is brought into contact with the rotatable heating member and conveys the sheet as nipping the sheet with the rotatable heating member.

### CROSS-REFERENCE TO RELATED APPLICATION

This application is based upon and claims the benefit of priority from the prior U.S. Patent Application No. 61/232,709, filed on Aug. 10, 2009, the entire contents of which are incorporated herein by reference.

This application is also based upon and claims the benefit of priority from Japanese Patent Application No. 2010-039466, filed on Feb. 25, 2010, the entire contents of which are incorporated herein by reference.

### FIELD

Exemplary embodiments described herein relate to a fuser, an image forming apparatus provided with the fuser, and a fusing method.

### BACKGROUND

In an image forming apparatus such as a copying machine or a printer, a toner image formed on an image carrier such as a photoconductor drum is transferred onto a sheet used as a recording medium, for example. This sheet is conveyed as being pressed against a rotatable heating member (a heat roller or a heat belt) so as to apply heat to the sheet, whereby the transferred toner image is fused onto the sheet. Conventionally, the rotatable heating member is heated by an induction heating coil over the total length thereof in the axial direction. When the sheet is brought into contact with the surface of the rotatable heating member, the sheet takes heat. The sheet that is subject to the fusing process includes one of A3 size (large sheet) and one of B5 size (small sheet). The fuser of this type has an issue that, when small-sized sheets having the same width are continuously subject to the fusing process, the temperature of the rotatable heating member is likely to excessively rise at a portion where the heat is not taken by the sheet. The excessive temperature rise deteriorates the rotatable heating member, which might cause a damage.

### BRIEF DESCRIPTION OF THE DRAWINGS

FIG. 1 is a perspective view of an image forming apparatus;

FIG. 2 is a sectional view of a fuser;

FIG. 3 is a perspective view illustrating a positional relationship between a heat roller and an induction heating coil;

FIG. 4 is a relationship diagram of a contact area of a sheet, having a different size, to a heat roller;

FIG. 5 is a side view of the heat roller in which a slit is formed on a metal conductive layer;

FIG. 6 is a diagram illustrating a modification of the metal conductive layer;

FIG. 7 is a diagram illustrating another embodiment of the fuser;

FIG. 8 is a diagram illustrating a fuser belt of the fuser; and

FIG. 9 is a diagram illustrating a fuser using a heat lamp.

### DETAILED DESCRIPTION

In general, according to one embodiment, there is provided a fuser including a rotatable heating member having a plurality of holes formed on difference areas, which are not overlapped with each other and which are the difference between an area in the rotating direction where a sheet having a first width is in contact during the conveyance and an area in the rotating direction where a sheet having a second width, different from the first width, is in contact during the conveyance, and a rotatable pressing member that is brought into contact with the rotatable heating member and conveys the sheet as nipping the sheet with the rotatable heating member.

Embodiments will be described below with reference to the drawings.

### First Embodiment

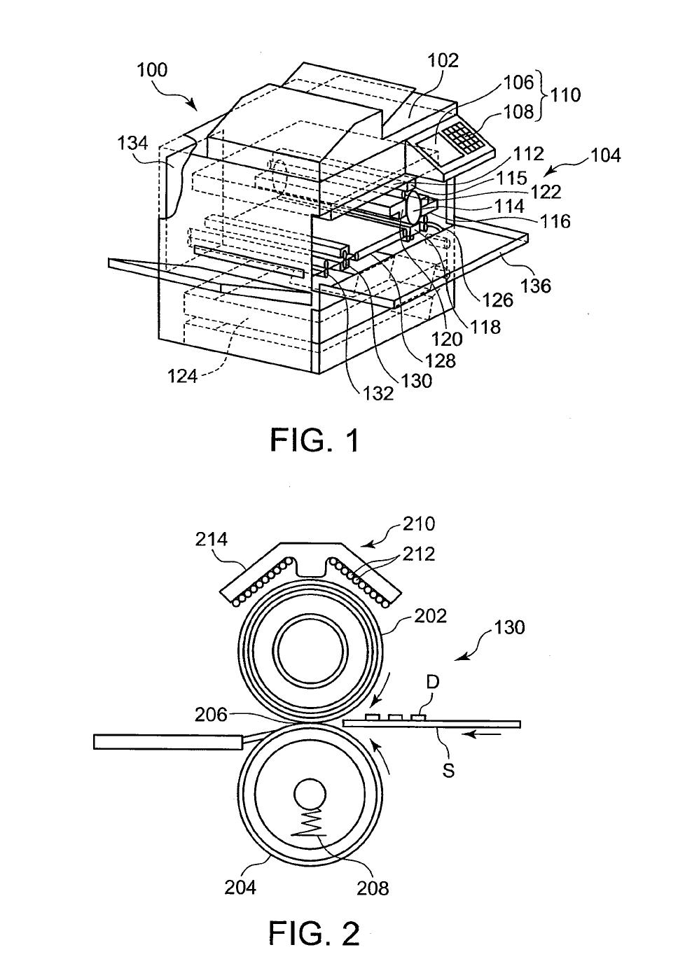

A first embodiment will be described with reference to FIGS. 1 to 6.

FIG. 1 is a perspective view of an image forming apparatus. The image forming apparatus 100 includes an image reader 102 that reads an image of a document and an image forming section that forms the read image data onto an image carrier such as a photoconductor drum as a toner image.

The image forming apparatus 100 transfers the toner image onto a sheet, and fused thereon. The image forming apparatus 100 exits the sheet having the toner image fused thereon. The image forming apparatus 100 includes a sheet feeder 124, a conveying path 126, a conveyor belt 128, a fuser 130, an exit roller 132, an electric board 134, and a maintenance door 136.

An operation panel 110 having a display 106 of a touch panel type and various operation keys 108 is provided at the upper part of the image forming apparatus 100. The operation keys 108 of the operation panel 110 include, for example, a ten-key, reset key, stop key, start key, and the like. A user inputs a size of a sheet, a number of copies, print density, and various processes such as a binding process.

The detailed configuration and operation of the respective sections in the image forming apparatus described above will be described below.

The image forming section 104 includes a laser unit 112, a photoconductor 114, a charger 115, a developing device 116, a transfer device 118, a cleaner 120, and a neutralization device 122. The charger 105 charges the outer peripheral surface of the rotating photoconductor 114. The laser unit 112 forms an electrostatic latent image, based on the image data read by the image reader 102, on the outer peripheral surface of the charged photoconductor 114. The developing device 116 develops the electrostatic latent image with toner into a toner image. The transfer device 118 transfers the toner image onto the photoconductor 114 onto a sheet S that is conveyed from the sheet feeder 124 through the conveying path 126. The cleaner 120 removes the toner that is not transferred and remains onto the photoconductor 114. The neutralization device 122 neutralizes the outer peripheral surface of the photoconductor 114.

The conveyor belt 128 conveys the sheet S, having a toner image D transferred thereon at the image forming section 104, to the fuser 130. The fuser 130 fuses the toner image D onto the sheet S. The exit roller 132 exits the sheet S, having the toner image D fused thereon, from the image forming apparatus 100.

FIG. 2 is a sectional view of the fuser 130.

The fuser 130 includes a heat roller 202 and a pressing roller 204 that are rotatable heating members. The heat roller 202 includes a cored bar, a foamed rubber layer, a metal conductive layer, a solid rubber layer, and a release layer, in order from the inner side. For example, the foamed rubber layer has a thickness of 5 mm, the metal conductive layer has a thickness of 50 μm, the solid rubber layer has a thickness of 200 μm, and the release layer has a thickness of 30 μm. The metal conductive layer is made of, for example, nickel, stainless, aluminum, or composite material of stainless and aluminum.

The pressing roller 204 includes, in order from its inner side, a cored bar, a rubber layer, and a release layer. For example, the rubber layer has a thickness of 1 mm, and the release layer has a thickness of 30 μm.

The diameters of the heat roller 202 and the pressing roller 205 are 40 mm, for example. As illustrated in FIG. 2, a pressing structure 208 such as a spring presses the pressing roller 204 against the heat roller 202 to form a nip 206. A motor rotary drives the heat roller 202 in a direction indicated in the figure, and the pressing roller 204 is driven with the rotation of the heat roller 202. The heat roller 202 conveys the sheet S, which is conveyed to the nip 206, as nipping the sheet S with the pressing roller 204, thereby applying pressure and heat to the surface of the sheet having the toner image D transferred thereon.

The fuser 130 also includes an induction heating coil 210 that is a heating member. The induction heating coil 210 opposes to the heat roller 202 with a space. The induction heating coil 210 includes a magnetic core 214, and a litz wire 212 wound around the core 214. The litz wire 212 includes plural conductor materials, each of which is made of heat-resistant polyamide, is insulated from each other, and bound. The magnetic core 214 is formed to have a curved shape so as to enclose the outer periphery of the heat roller 202, for example.

When a high-frequency current is applied, the induction heating coil 210 generates a magnetic flux. This magnetic flux produces a magnetic flux and eddy current to the metal conductive layer of the heat roller 202 so as to prevent the change in the magnetic field. A Joule heat is generated due to the eddy current and the resistance of the metal conductive layer, whereby the heat roller 202 is heated.

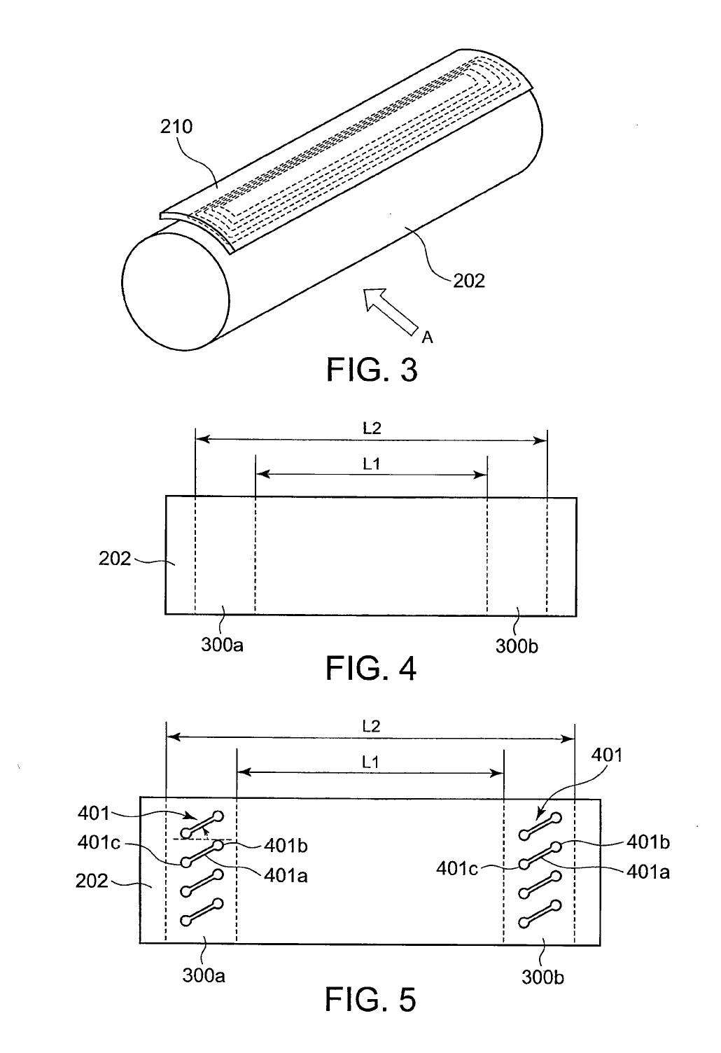

FIG. 3 is a perspective view illustrating a positional relationship between the heat roller 202 and the induction heating coil.

The induction heating coil 210 is arranged to face the total area of the heat roller 202 in the direction of the rotational shaft with a fixed space. The heating capability of the total area of the heat roller 202 which the induction heating coil 214 faces is substantially uniform.

Next, a contact area of the respective sheets S and the heat roller 202 when a small-sized sheet (e.g., A4 size) and a large-sized sheet (e.g., A3 size) are conveyed to the fuser will be described with reference to FIG. 4. FIG. 4 illustrates the relationship between the area where the heat roller 202 and the A4 sheet are in contact with each other and the area where the heat roller 202 and the A3 sheet is in contact with each other in the direction of the rotation axis of the heat roller 202. The short side of the A4 sheet S and the short side of the A3 sheet are defined as a widthwise direction thereof, respectively. The short side of the A4 sheet S is referred to as L1, while the short side of the A3 sheet S is referred to as L2. In this case, the relationship of L1<L2 is established. The width of the A3 sheet is the maximum width that the sheet is in contact with the heat roller 202.

There are areas, where the A3 sheet is in contact but the A4 sheet is not in contact during the conveyance of the sheet, in the rotating direction at both side ends of the heat roller 202 in the direction of the rotation axis. The areas 300a and 300b (difference area), which are not overlapped with each other, are the areas where heat is not taken by the sheet in the rotating direction, compared to the area of the width L1, when the A4 sheets S are continuously fed.

FIG. 5 is a side view of the heat roller 202 according to the present embodiment viewed from the conveying direction of the sheet, i.e., a direction of an arrow A in FIG. 3.

The areas 300a and 300b, which are the difference of the areas where the respective sheets pass, are present when the A4 sheet S passes through the heat roller 202 and when the A3 sheet S passes through the heat roller 202. A plurality of slit-like holes (hereinafter referred to as slits) is formed on the metal conductive layer of the heat roller 202 at the difference areas 300a and 300b.

The slits 401 formed on the metal conductive layer cut the magnetic field produced by the induction heating coil 210, which is provided to face the slits 401. Therefore, the heat-generating capability is decreased, compared to the area of the heat roller 202 where the slits 401 are not formed.

When each of the slits 401 increases, the area of the hollow space of the metal conductive layer of the heat roller 202 increases, which might reduce the strength of the heat roller 202. Accordingly, the length of each of the slits 401 is set to be about 5 mm, for example. The formation of the slits 401 at the position very close to the end of the heat roller 202 might reduce the strength of the heat roller 202. Therefore, the slits 401 are formed at the inner side from the end of the heat roller 202 by about 10 mm or more.

The slits 401 are equally spaced in order to prevent the occurrence of image irregularity with a rotating cycle of the heat roller 202. The slits 401 are also provided not to be parallel to the direction of the rotation axis of the heat roller 202. When the slits 401 are formed parallel to the direction of the rotation axis of the heat roller 202, the heat roller 202 is prominently divided into the portion where the slits 401 are formed and the portion where the slits 401 are not formed in the rotating direction of the heat roller 202. Specifically, a temperature variation might be caused in the rotating direction of the heat roller 202. When the slits 401 are formed to have a slope with respect to the direction of the rotation axis of the heat roller 202, the portion where the slits 401 are not at all formed is reduced in the rotating direction of the heat roller 202, whereby the temperature of the heat roller 202 in the rotating direction at the area where the slits 401 are formed is kept to be uniform.

Each of the slits 401 is formed to have a non-cutting round shape at both ends. Specifically, each of the slits 401 has a straight-line portion 401a, and circular portions 401b and 401c at both ends of the straight-line portion 401a. This is because, when the end of the slit 401 is angular, the slit 401 might be split from the angular portion.

The slit 401 is formed on the metal conductive layer, not on the release layer at the surface of the heat roller 202. The reason is as follows. Specifically, when the slit 401 is formed on the release layer, the image at the slit 401 might not satisfactorily be fused, since the release layer is a portion that is brought into contact with the sheet, whereby an image defect might be generated. Therefore, the slit 401 is formed only on the metal conductive layer that is formed at the inner side of the release layer.

As described above, the slit 401 is formed on the metal conductive layer of the heat roller 202 without increasing the number of the components of the apparatus. Thus, when a small-sized sheet and a large-sized sheet are fed to the fuser, particularly when small-sized sheets are continuously fed, the configuration can prevent the portion on the heat roller 202 from being generated, where the temperature excessively rises, because the area that is brought into contact with the heat roller 202 is different.

In the above-mentioned embodiment, slit-like holes are formed on the areas 300a and 300b, which are the difference of the areas that are brought into contact with the heat roller, between when the A4 sheet passes and when the A3 sheet passes. However, the size of the sheet is not limited thereto. The local excessive temperature rise of the heat roller can effectively be prevented by forming the holes at the areas, which are the difference of the areas where a small-sized sheet and a large-sized sheet that are frequently used are in contact with the heat roller.

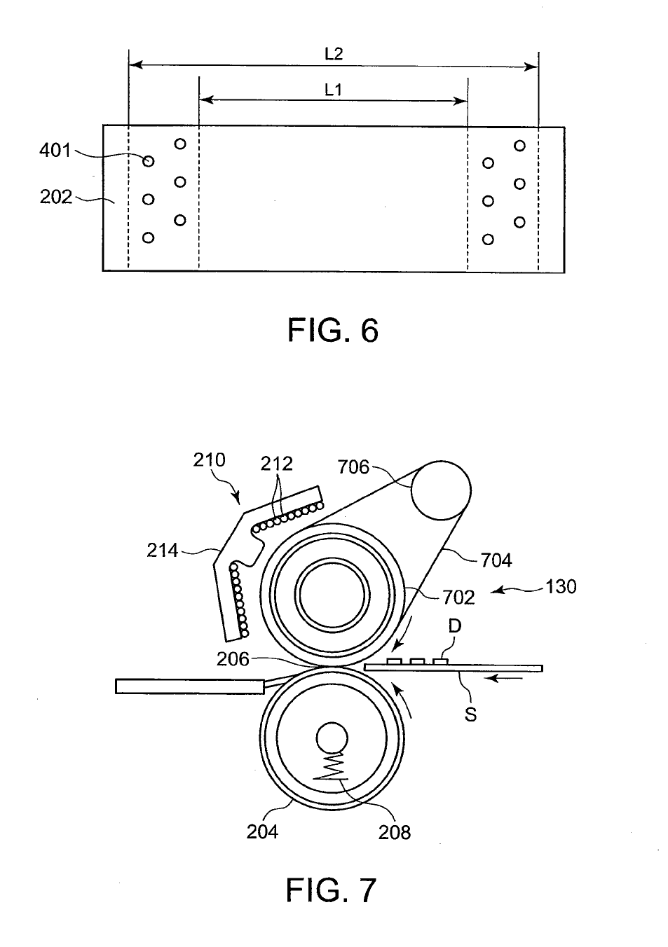

In the above-mentioned embodiment, the holes formed on the metal conductive layer of the rotatable heating member have a slit-like shape. However, the shape of each hole may be circular as illustrated in FIG. 6.

In the above-mentioned embodiment, the heat roller is heated by an electromagnetic induction heating system using the induction heating coil as the heating member. However, the heating method of the heat roller is not limited thereto. For example, a heat lamp 310 may be used as illustrated in FIG. 9. When the heat lamp 310 is used, the portion of the heat roller 202 having the metal conductive layer is more heated compared to the portion having no metal conductive layer. Therefore, regardless of the induction heating system, the formation of the holes on the metal conductive layer of the heat roller 202 is effective to prevent the local excessive temperature rise of the heat roller in any other heating methods.

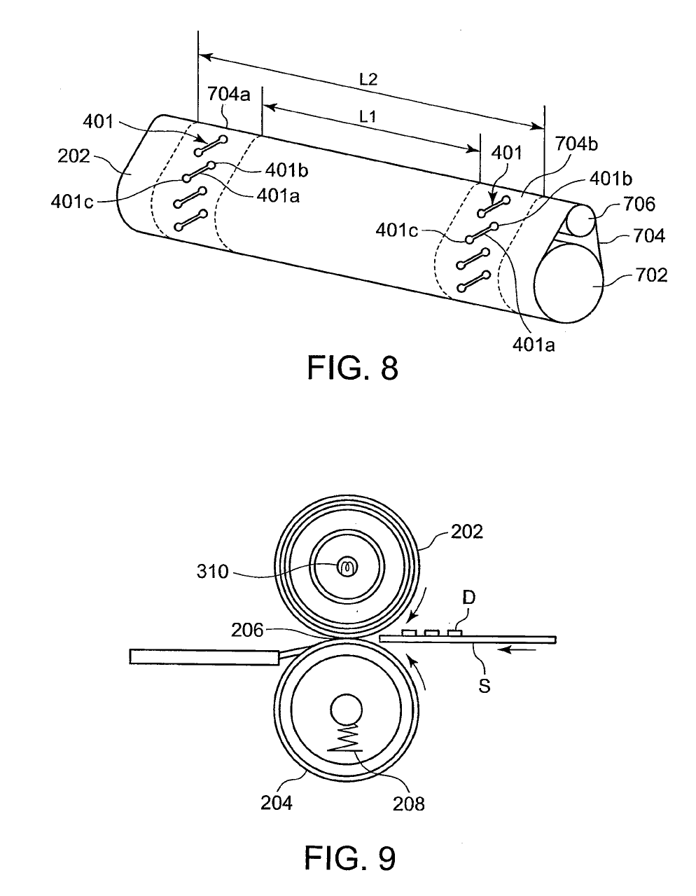

Next, a second embodiment will be described with reference to FIGS. 7 and 8.

### Second Embodiment

A fuser according to the present embodiment includes an endless belt serving as a rotatable heating member, instead of the heat roller 202 in the fuser according to the first embodiment.

FIG. 7 illustrates the fuser according to the second embodiment.

The fuser 130 includes a fuser roller 702, an endless belt 704 looped around a satellite roller 706, and a pressing roller 204 serving as a nip forming member. The satellite roller 706 rotatably supports the belt 704 together with the heat roller 702. The satellite roller 706 rotates together with the belt 704 that is driven by the heat roller 702.

The fuser roller 702 is formed by applying a foamed rubber layer around a core bar, for example. The satellite roller 706 is made of a ceramic, for example. The satellite roller 706 may be made of iron, stainless steel, resin, etc., or may be made of a heat pipe, for example.

The belt 704 includes, in order from its inner side, a coat layer, a metal conductive layer, an elastic layer, and a release layer. It generates a Joule heat by a magnetic flux applied from the induction heating coil 210. The coat layer may be formed by dispersing mica in polyimide resin. The metal conductive layer is made of nickel, stainless, aluminum, or a composite member of stainless and aluminum, for example. The elastic layer may be made of a silicon rubber or a fluorine-containing rubber, and the release layer may be made of a fluorine resin.

The pressing roller 204 is in pressed contact with the fuser roller 702 and the belt 704. A nip 206 is formed between the belt 704 and the pressing roller 204 due to the press-contact of the pressing roller 204. The sheet S is conveyed to the nip 206, where the toner image on the sheet S is fused.

In the fuser 130, slits 401 are formed on the metal conductive layer of the belt 704. FIG. 8 illustrates the belt 704. Like the holes formed on the heat roller 202 in the first embodiment, the holes are formed on areas 704a and 704b, which are the difference of the areas where the respective sheets pass on the belt 704, when the A4 sheet S passes through the belt 704 and when the A3 sheet S passes through the belt 704. The slits 401 are formed so as not to be parallel to the rotation axis, and are formed to have a non-cutting round shape at both ends. Specifically, each of the slits 401 has a straight-line portion 401a, and circular portions 401b and 401c at both ends of the straight-line portion 401a.

The shape of the slit 401 as a hole is not limited to those illustrated in FIGS. 5 and 8. The slit-like hole includes an elongated hole, a gap, an oval hole, and an elliptic hole etc. that have a long space portion in one direction.

When the belt is used as the rotatable heating member, the effect same as the heat roller according to the first embodiment can be obtained, as described in the above embodiment.

According to the embodiments described above, the local excessive temperature rise of the rotatable heating member can be prevented with a simple configuration without making the apparatus complicated.

While certain embodiments have been described, those embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. A fuser comprising:
a rotatable heating member having a plurality of holes formed on difference areas, which are not overlapped with each other and which are the difference between an area in the rotating direction where a sheet having a first width is in contact during the conveyance and an area in the rotating direction where a sheet having a second width, different from the first width, is in contact during the conveyance; and
a rotatable pressing member that is brought into contact with the rotatable heating member and conveys the sheet as nipping the sheet with the rotatable heating member.

2. The fuser according to claim 1, wherein
the rotatable heating member has a metal conductive layer, wherein the holes are formed on the metal conductive layer.

3. The fuser according to claim 2, further comprising:
an induction heating coil that is formed along the rotatable heating member to electromagnetically heat the metal conductive layer.

4. The fuser according to claim 2, further comprising:
a heat lamp provided in the rotatable heating member.

5. The fuser according to claim 5, wherein
the holes are arranged at equal intervals.

6. The fuser according to claim 5, wherein
each of the holes are formed to have a slit-like shape.

7. The fuser according to claim 6, wherein
each of the holes formed to have the slit-like shape has circular both ends.

8. The fuser according to claim 6, wherein
each of the holes formed to have the slit-like shape is formed in the direction of the rotation axis of the rotatable heating member with a predetermined angle.

9. The fuser according to claim 1, wherein
the rotatable heating member is an endless belt.

10. An image forming apparatus comprising:
a sheet feed section that feeds a sheet;
an image forming section that forms an image on the sheet;
a rotatable heating member having a plurality of holes formed on difference areas, which are not overlapped with each other and which are the difference between an area in the rotating direction where a sheet having a first width is in contact during the conveyance and an area in the rotating direction where a sheet having a second width, different from the first width, is in contact during the conveyance; and
a rotatable pressing member that is brought into contact with the rotatable heating member and conveys the sheet as nipping the sheet with the rotatable heating member.

11. The image forming apparatus according to claim 10, wherein
the rotatable heating member includes a metal conductive layer, wherein the holes are formed on the metal conductive layer.

12. The fuser according to claim 11, further comprising:
an induction heating coil that is formed along the rotatable heating member to electromagnetically heat the metal conductive layer.

13. The fuser according to claim 10, wherein
the holes are arranged at equal intervals.

14. The fuser according to claim 13, wherein
each of the holes are formed into a slit-like shape.

15. The fuser according to claim 14, wherein
each of the holes formed to have the slit-like shape has circular both ends.

16. The fuser according to claim 14, wherein
each of the holes formed to have the slit-like shape is formed in the direction of the rotation axis of the rotatable heating member with a predetermined angle.

17. The fuser according to claim 10, wherein
the rotatable heating member is an endless belt.

18. A fusing method comprising:
preparing a rotatable heating member having a metal conductive layer;
forming difference areas, which are not overlapped with each other and which are the difference between an area in the rotating direction where a sheet having a first width is in contact during the conveyance and an area in the rotating direction where a sheet having a second width, different from the first width, is in contact during the conveyance, and forming a plurality of holes on the metal conductive layer corresponding to the areas; and
electromagnetically heating the metal conductive layer by an induction heating coil, which is formed along the rotatable heating member, so as to cut a magnetic field generated at the portion opposite to the plurality of holes.

19. The method according to claim 18, wherein
the holes are arranged at equal intervals.

20. The method according to claim 19, wherein
each of the holes are formed to have a slit-like shape.
